(19) United States
(12) Patent Application Publication
(10) Pub. No.: US 2014/0192958 A1
(43) Pub. Date: Jul. 10, 2014

(54) Dynamic Dose Reduction in X-Ray Inspection

(71) Applicant: American Science and Engineering, Inc., Billerica, MA (US)

(72) Inventors: Dan-Cristian Dinca, Chelmsford, MA (US); Martin Rommel, Lexington, MA (US); Seth Van Liew, Waltham, MA (US); Aleksandr Saverskiy, North Andover, MA (US)

(73) Assignee: American Science and Engineering, Inc., Billerica, MA (US)

(21) Appl. No.: 14/146,168

(22) Filed: Jan. 2, 2014

Related U.S. Application Data
(60) Provisional application No. 61/748,789, filed on Jan. 4, 2013.

(51) Int. Cl. G01N 23/02

(52) U.S. Cl. CPC G01N 23/02
USPC 378/64

(57) ABSTRACT

Methods and an x-ray system for dynamically regulating x-ray dose. An x-ray beam is generated and collimated at a source collimator and detected after the x-ray beam traverses an inspected object. A filter may be dynamically interposed by translation of the filter between a focal spot of the source and the source collimator in such a manner as to maintain the portion of the x-ray beam that traverses the inspected object below a specified limit. Alternatively, an aperture of the source collimator may be varied in size or position relative to the focal spot.

The present application claims the priority of U.S. Provisional Patent Application Ser. No. 61/748,789, filed Jan. 4, 2013, which is incorporated herein by reference.

### TECHNICAL FIELD

The present invention relates to methods and systems of inspection using x-ray radiation, and, more particularly, to methods and systems whereby x-ray dose is reduced during the course of inspection.

### BACKGROUND OF THE INVENTION

FIG. 1 depicts a typical cargo inspection system employing an x-ray transmission technique. A fan-shaped beam 12 of penetrating radiation, emitted by a source 14 (otherwise referred to herein as a “beam source,” or, more particularly, as an “accelerator”—based on the source of electrons employed to generate x-rays), is detected by elements of a detector array 16 distal to a target object (here, truck 10) in order to produce images of the target object. Beam 12 may be referred to herein, without limitation, as an “x-ray beam,” though, based on the energy and origin of the particles (typically photons) employed, the beam may be a gamma-ray beam or other sort of beam, within the scope of the present invention.

Particular contents of the target object 10 (otherwise referred to herein as an “inspected object,” or simply as an “object”) may be discriminated and characterized on the basis of the transmission of penetrating radiation through the object and its detection by detector array 16 and its individual detector modules 18. (As used herein, the term “detector module” refers to one or more detector element in conjunction with its associated preprocessing electronics.) Signals from each of the detector modules, suitably pre-processed, provide inputs to processor 19, where material characteristics are computed.

In such x-ray inspection systems, image quality often depends upon the flux of radiation, in total or as a function of x-ray energy, passing through the object being inspected and reaching the detectors. Increased flux is typically concomitant with increased radiation dose to the inspected cargo as well as to the ambient environment. In order to keep the amount of radiation to the environment low, shielding is used to attenuate both direct and scattered radiation. The scattered radiation is particularly difficult to shield because shielding scattered radiation requires that attenuating material be added close to the object that is being inspected, thereby contributing, by a large fraction, to the scattered radiation. For open systems such as high energy gantries, the foregoing considerations are challenging.

Inspected objects, such as cargo containers, are not always filled with highly attenuating quantities of material, and a significant fraction of the incident x-ray beam may traverse, or be scattered out of, the container. Using the full x-ray beam power for the lightly attenuating portions has the effect of increasing the dose both to cargo and environment without providing significant image quality improvement. Methods to reduce the dose to cargo and to environment without impacting the image quality would thus be very desirable.

Methods for modulating the intensity of an x-ray beam include methods for interposing a translating or rotating filter between an x-ray source and a source collimator, as shown, for example, in U.S. Pat. No. 5,107,529 (to Boone), which describes the combination of a set of attenuating patterns. US Published Application 2006/0062353 A1 (to Yatsenko et al.) summarizes methods of modulating an X-ray beam, at pars. [0008]-[0019]. Both of the foregoing documents are incorporated herein by reference.

Some methods for real-time dose mitigation are known in the art, such as those described in U.S. Pat. No. 6,067,344 (to Grodzins et al.), entitled “X-Ray Ambient Level Safety System,” incorporated herein by reference.

### SUMMARY OF EMBODIMENTS OF THE INVENTION

In accordance with various embodiments of the present invention, methods are provided for dynamically regulating x-ray dose. The methods have steps of:
generating an x-ray beam by impinging an electron beam upon an x-ray
production target at a focal spot;
collimating the x-ray beam at a source collimator;
detecting a portion of the x-ray beam that traverses an inspected object; and
dynamically interposing a filter by translation of the filter between the focal spot and the source collimator in such a manner as to maintain the portion of the x-ray beam that traverses the inspected object below a specified limit.

In accordance with other embodiments of the present invention, the filter may be a whole-beam filter, and, additionally or alternatively, may preferentially absorb lower-energy x-rays. Absorption by the filter may be a function of filter position. In further embodiments, the filter may be a wedge filter. Absorption by the filter may vary in a stepped manner with respect to filter position. The filter may also be a partial beam filter.

In accordance with yet other embodiments of the invention, other methods are provided for dynamically regulating x-ray dose. These methods have steps of:
generating an x-ray beam by impinging an electron beam upon an x-ray production target at a focal spot;
collimating the x-ray beam at a source collimator; and
varying an aperture of the source collimator.

The step of varying may include changing an aperture size of the source collimator, or changing a relative position of the focal spot and the source collimator.

In further embodiments, methods are provided for dynamically regulating x-ray dose, having steps of:
generating an x-ray beam by impinging an electron beam upon an x-ray production target at a focal spot;
collimating the x-ray beam at a source collimator; and
varying a dimension characterizing the focal spot.

In any of the foregoing methods, varying a dimension characterizing the focal spot may include defocusing the focal spot.

In accordance with another aspect of the present invention, methods are provided for dynamically regulating x-ray dose by:
generating an x-ray beam by impinging an electron beam upon an x-ray production target at a focal spot; and
varying a characteristic of the generated x-ray beam in response to radiation detected upon interaction of the x-ray beam with an inspected object.

The characteristic of the generated x-ray beam that is varied may include spectral content of the x-ray beam, or flux of the x-ray beam, for example. It may also include a temporal characteristic of the x-ray beam such as pulse duration or frequency. It may also include variation in the frequency per unit time of interspersed pulses of electrons characterized by distinct energies, and in the ratio of the frequencies of such interspersed pulses.

In accordance with yet another aspect of the invention, an x-ray system is provided for generating an x-ray beam of dynamically regulated dose. The x-ray system has an electron accelerating structure for accelerating a beam of electrons for formation of a focal spot on an x-ray producing target and for generating an x-ray beam. The x-ray system also has a source collimator for collimating the x-ray beam, and a filter dynamically interposable by translation between the focal spot and the source collimator. The dynamically interposable filter may be a whole beam filter or a partial beam filter. The x-ray system has a detector for receiving a portion of the x-ray beam that traverses an inspected object and for generating a detector signal, and a processor adapted to dynamically interpose the filter between the focal spot and the source collimator on a basis of the detector signal.

### BRIEF DESCRIPTION OF THE FIGURES

The foregoing features of the invention will be more readily understood by reference to the following detailed description, taken with reference to the accompanying figures, in which:

FIG. 1 is a perspective view of an x-ray transmission cargo inspection system in the context of which embodiments of the present invention may usefully be applied.

FIG. 2 is a schematic cross section depicting typical components of an x-ray emission system in accordance with embodiments of the present invention.

FIG. 3 is a schematic cross section of an embodiment of the present invention employing a translating x-ray filter.

FIG. 4 is a schematic cross section of an embodiment of the present invention employing a rotating x-ray filter.

FIGS. 5A and 5B are top and perspective views, respectively, of a dose reduction system employing a binary filter arrangement in accordance with the present invention. FIGS. 5C and 5D are top and perspective views, respectively, of a dose reduction system employing a step filter arrangement in accordance with the present invention.

FIG. 6 is a schematic cross section of an embodiment of the present invention employing an aperture of variable size for dynamic dose rate control.

FIG. 7 is a schematic cross section of an embodiment of the present invention employing a rotating collimator for dynamic dose rate control.

FIG. 8 is a plot of target current versus time, illustrating the use of variable pulse duration to control x-ray dose in accordance with an embodiment of the present invention.

FIG. 9A depicts an unobscured focal spot as seen through a collimating aperture, and FIG. 9B depicts changing the dose rate by partially occluding the x-ray focal spot projection into the collimating aperture, in accordance with an embodiment of the present invention.

FIG. 10A depicts a focused focal spot as seen through a collimating aperture, and FIG. 10B depicts changing the dose rate by defocusing the x-ray focal spot projection into the collimating aperture, in accordance with an embodiment of the present invention.

FIG. 11 plots focal spot distributions for two focusing states, in accordance with an embodiment of the present invention.

FIG. 12 is a flowchart depicting a scanning method for reduced radiation footprint system based on an interlaced dual-energy X-ray source, in accordance with an embodiment of the present invention.

### DETAILED DESCRIPTION OF EMBODIMENTS OF THE INVENTION

Definitions. As used herein and in any appended claims, the term “beam” refers to a flux of particles (including photons or other massless particles) having a predominant direction referred to as the direction of the beam. Any plane containing the direction of the beam may be referred to as a plane of the beam.

The term “image” shall refer to any multidimensional representation, whether in tangible or otherwise perceptible form, or otherwise, whereby a value of some characteristic (such as fractional transmitted intensity through a column of an inspected object traversed by an incident beam, in the case of x-ray transmission imaging) is associated with each of a plurality of locations (or, vectors in a Euclidean space, typically [symbol] ²) corresponding to dimensional coordinates of an object in physical space, though not necessarily mapped one-to-one thereonto. An image may comprise an array of numbers in a computer memory or holographic medium. Similarly, “imaging” refers to the rendering of a stated physical characteristic in terms of one or more images.

As used herein, when the terms “high” and “low” are used in conjunction with one another, the terms are to be understood in relation to one another. Thus, “low energy”, or “lower energy,” refers to radiation which is characterized by a lower endpoint energy than radiation which is characterized as “high energy” or “higher energy.” When used alone, the term “high energy” or “hard,” describing radiation, refers to radiation characterized by an endpoint energy of at least 1 MeV per particle.

As used herein, the term x-ray “dose” shall refer to the total energy fluence incident upon a specified area during a specified interval of time, such as that defined by a pulse. The term “dose rate,” while indicative of power flux, shall be used interchangeably with “dose” for all purposes, within the context of the present description.

As used herein, the term x-ray “scan” shall refer to a variation of a spatial orientation of an x-ray beam or to the relative motion of the beam relative to a medium being inspected for the purpose of characterizing a medium, as by imaging.

The term “detector” may be used without limitation herein to refer to an element of a multi-element detector array, or to an entire detector array, or to a detector module, including preprocessing electronics, as the context warrants.

The adverb “dynamically,” as applied to variation of a parameter or a position, shall refer to varying such parameter or position as a function of time, typically in response to some measurement.

The adverb “adaptively,” as applied to variation of a parameter or a position, shall refer to varying such parameter or position in response to some measurement.

As used herein and in any appended claims, an electron beam may be said to be characterized by two (or more) “distinct energies,” by which is meant that the electron beam is comprised of a chain of pulses, some of which are characterized by a first energy, and others of which are characterized by another energy. The first energy may be referred to as a lower energy (LE), for example, while another energy may be referred to as a higher energy (HE), again, for example. There may, of course, be any number of intervening energies as well.

Pulses of distinct electron energies impinging on an x-ray production target produce, through bremsstrahlung, distinct x-ray spectra, with end-point energies governed by the distinct energies of the respective incident energy beams.

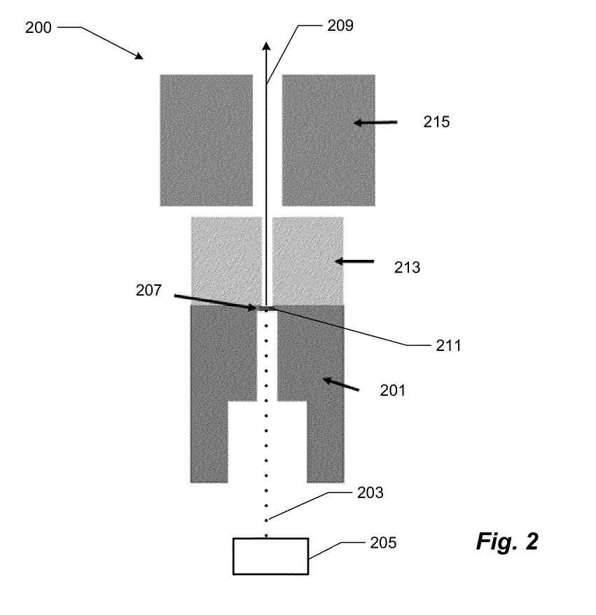

In accordance with embodiments of the present invention, described now with reference to FIGS. 2-13, various techniques and systems are provided for forming x-ray beams of various cross-sectional shapes, such as pencil or fan beams, for example. Typical components of an x-ray emission system 200 in accordance with embodiments of the present invention are shown in FIG. 2. Some embodiments of the present are particularly suited to high-energy x-ray scanners. Electron accelerating structure 201 brings electron beam 203 from an electron source 205 to a desired high energy, as defined above.

Electron beam 203 impinges upon x-ray production target 207, (usually tungsten) and produces x-rays 209 via a bremsstrahlung process. The position where electron beam 203 impinges upon x-ray production target 207 may be referred to herein as x-ray focal spot (or “focal spot”) 211. In certain embodiments of the present invention, a beam focusing and steering system may be interposed between the electron accelerating structure 201 and the X-ray production target 207. Accelerating structure 201 may be understood as encompassing any accelerator, including a linac, for example, without limitation. The accelerating structure and x-ray production target, taken together, may be referred to herein as an “x-ray source.”

A focal spot collimator 211 for shielding unwanted x-rays is followed by one or more source collimators 213 and further shielding components. Source collimator 213 may also be referred to herein as an “inner collimator,” and may be followed by one or more subsequent outer collimators 215.

X-rays 209 emitted by x-ray emission system 200 may be characterized by an x-ray dose per pulse, in cases where electron source 205 is pulsed. Pulses emitted by x-ray emission system 200 may be referred to, for convenience herein, as “linac pulses”.

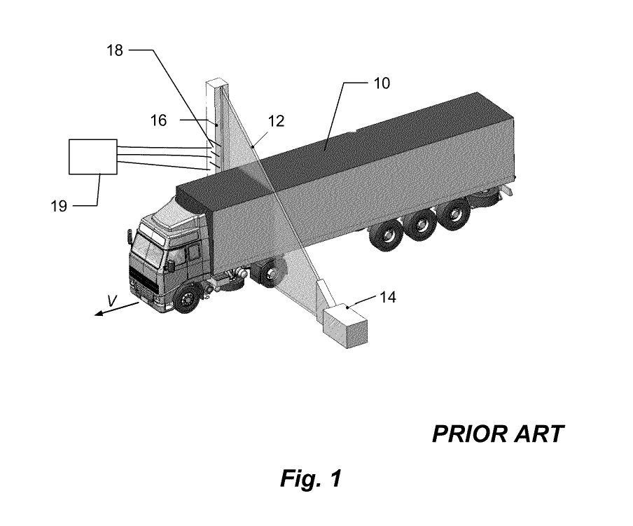

Embodiments of the present invention provide for dynamically varying and adjusting the dose per pulse during the course of an x-ray scan by changing parameters of one or more of components of x-ray emission system 200 as described above. Dynamic dose control may be performed by commands of a processor 19 (shown in FIG. 1) on the basis of signals generated by detectors 18 (shown in FIG. 1) disposed to detect radiation from x-ray emission system 200 that has interacted with an inspected object 10 (shown in FIG. 1), typically by transmission therethrough. Processor 19 dynamically varies and adjusts the dose per pulse by interposing a filter or by changing one or more parameters of a component of the x-ray emission system in order to maintain the detector signal generated by one or more detectors 18 below a specified value or limit.

Methods for pulse-to-pulse dose reduction in accordance with the present invention may be characterized as follows, for heuristic purposes and without limitation, and understanding that some methods may employ more than one of the enumerated bases:
Methods based on an x-ray beam filter
   Whole beam filters
   Partial beam filters
Methods based on x-ray beam collimation
   Variable beam width
   Reduced focal spot opening
Methods based on varying beam source parameters
   Change in the number of pulses per second
   Change in the duration of the linac pulse
   Change of the linac energy or electron current on the x-ray production target
   Change in the ratio of pulses per unit time of one energy to pulses of a second energy
Methods based on x-ray focal spot
   Change in the focal spot position
   Change in the focal spot focus

As stated above, the forgoing methods need not be mutually exclusive, and, for certain applications, compatible combinations of any two or more methods can be used.

Several exemplary embodiments of the present invention are now described in greater detail.

### Whole Beam Filters

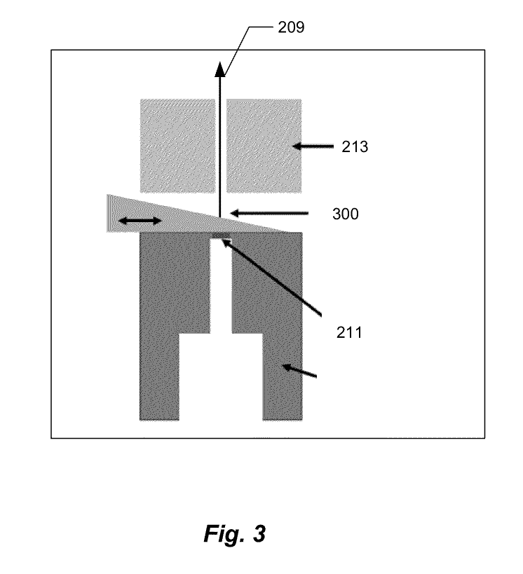

Beam filters attenuate the beam by absorbing a certain amount of x-rays. (The term “amount”, as used herein with reference to electromagnetic radiation, may refer, without limitation, to energy, power, spectral distribution, or any combination thereof) Advantage may be taken of preferential absorption of large numbers of lower-energy x-ray photons in beam filters. In fact, absorption typically decreases with energy, starkly (with an exponential coefficient of absorption decreasing as ˜ε⁻³) at energies below those where attenuation comes to be dominated by Compton scattering. As a consequence, the reduction in dose upon insertion of a whole beam filter is much larger than the penalty paid in image quality reduction. A translating x-ray filter 300 is depicted in FIG. 3 and is an example of a whole beam filter.

### Wedge Filters (Translation)

With reference to FIG. 3, a translating x-ray filter 300 formed from an x-ray absorbing material (such as steel, for example) with known properties is translated a predetermined length in front of the focal spot 211 to create a resulting x-ray beam 209 with reduced dose rate at the entrance of the source collimator 213. The foregoing x-ray absorbing material may be referred to herein as a “filter.” Each position of the filter corresponds to a specific x-ray dose per pulse. The filter may be moved, during phases of the inspection process, to a location corresponding to the dose rate sought for the next pulse or set of pulses. For example, the filter may be moved in response to detected transmission through an inspected object, or between scanning a cab and trailer of a cargo-bearing vehicle, etc.

Use of step wedges that interpose a discrete set of filtration thicknesses in the beam is sometimes desirable. A nonlinear profile or a wedge composed of multiple materials may also be employed within the scope of the present invention.

### Rotating Filters

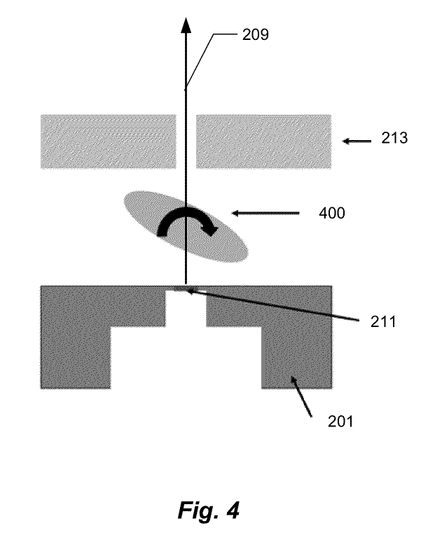

Referring to FIG. 4, a rotating x-ray filter (or “rotating filter”) 400 formed of an x-ray absorbing material (e.g., steel) with known properties may be rotated a predetermined angle in front of the focal spot 211 to create a resulting x-ray beam 209 with reduced dose rate at the entrance of the source collimator 213. In a manner similar to that described above with reference to the translating filter, each position of rotating filter 400 corresponds to a pre-measured x-ray dose rate. The rotating filter is rotated, during phases of an inspection process, or in response to measured transmission through an inspected object, to yield a dose rate sought for the next pulse.

### Partial Beam Filters

It is often the case that only a portion of cargo undergoing x-ray inspection contains highly-attenuating materials. These dense regions of cargo often intersect only a fraction of the beam in the vertical direction. By partially blocking the beam, these dense regions can be isolated for full flux, while less-dense regions above or below it on the same scan line can be heavily filtered so that they receive reduced flux. This will modulate the intensity far more than a system that only regulates the whole line.

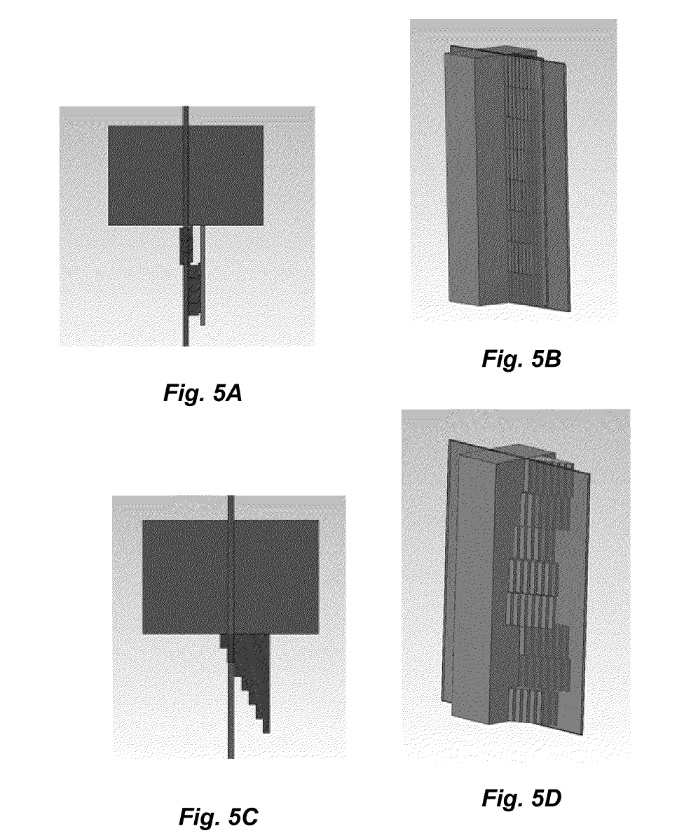

Two systems that may be used to accomplish the foregoing modulation within the scope of the present invention are now described with reference to FIGS. 5A-5D. In both systems, an actuator (not shown) moves one or more filter elements into the beam. In one embodiment, shown in the top view of FIG. 5A and perspective view of FIG. 5B, a system of binary filter blocks is employed. Each block has two positions: in-the-beam and out-of-the-beam. The amount of filtration for a given area is determined by the number of blocks in the beam. The number of blocks in the beam direction determines the number of levels of filtration. The number of blocks perpendicular to the beam determines the number of areas of cargo that can be isolated vertically.

Another way to accomplish the aforesaid modulation is with a series of step filters (or wedge filters) as shown in top view in FIG. 5C and in perspective view in FIG. 5D. This is similar to the system described in the foregoing section, except instead of binary filter blocks (as in FIG. 5A), each filter block is a step, with the number of levels of filtration given by the number of steps. The main advantage of this approach is that it requires fewer moving parts. The main disadvantage is that each part is more complicated, and filters have a longer distance to travel to get to the desired level, so the response will not be as fast.

### Reduced Focal Spot Opening

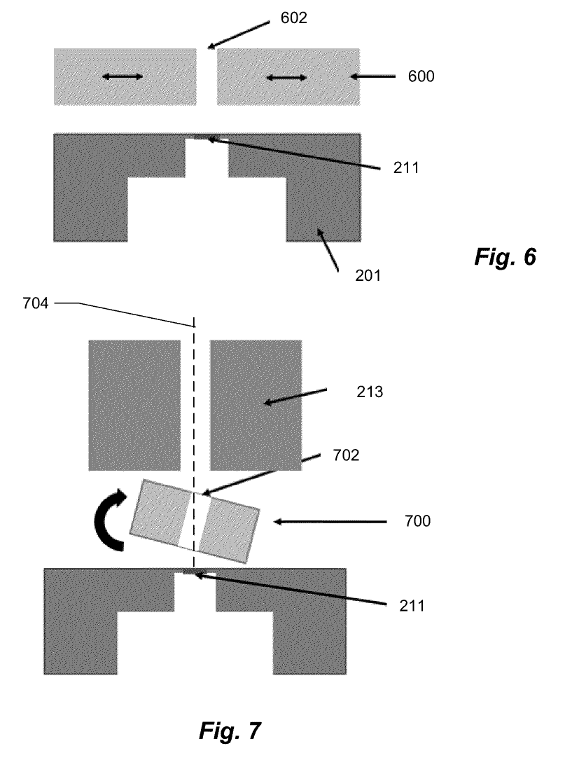

Referring now to FIG. 6, a variable beam width is generated by dynamically modifying the geometry of variable-gap inner collimator 600 (one, or multiple-piece collimators) as shown. Both sides of variable gap collimator 600 are moved symmetrically to vary gap 602 to create a beam profile that is symmetric while allowing the dose rate to be varied between phases of an inspection or in response to a level of x-rays transmitted through an inspected object. There is a linear dependence between the dose to cargo and scattered dose to environment and the size of aperture 602.

In a further embodiment, depicted in FIG. 7, a rotating collimator 700 creates a variable gap by creating an angle between beam axis 704 and the rest of the collimators 213 and aperture 702 within the rotating collimator.

### Variable Pulse Rate

Each pixel in an x-ray image viewed by the operator usually contains information obtained from averaging or processing multiple linac pulses. In this approach the number of linac pulses per second is dynamically changed during the scan as the amount of X-ray attenuation in the object inspected varies such that the contrast-to-noise ratio per pixel in the image viewed by the operator does not decrease significantly.

### Variable Length of the Linac Pulse

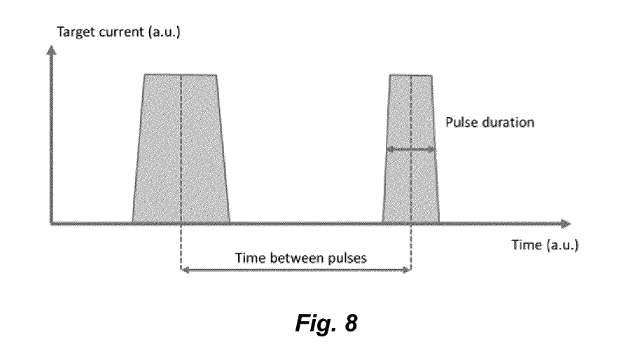

The flux of the x-ray pulse may be changed on a pulse-to-pulse basis by shortening the duration of the linac pulse, as depicted in FIG. 8, and as explained in U.S. Pat. Nos. 6,459,761 and 6,067,344, which are incorporated herein by reference.

### Variable Linac Energy or Electron Current on the X-ray Production Target

X-ray flux produced via bremsstrahlung by electrons impinging on an x-ray production target is directly proportional to the electron current incident on the target. By varying the current on a pulse-to-pulse basis, the x-ray flux can be adjusted linearly.

For x-rays produced by bremsstrahlung targets in the MeV range, the dose rate roughly varies with the third power of the energy of the electron beam. By changing the energetic composition of the beam by even a small amount, the dose rate from pulse to pulse can be adjusted significantly. Adjustment of the linac energy or electron current, thus varying spectral or flux characteristics of the resultant x-ray beam, may be accomplished in response to radiation detected after transmission of the x-ray beam through, or scattered by, an inspected object.

More particularly, in cases where the pulse stream is based upon varying the electron beam among a multiplicity of energies from pulse to pulse, the number of pulses per unit time of each respective energy pulse may be varied on the basis of the x-ray beam detected after transmission through the inspected object. Thus, for example, if the stream of pulses is characterized by a sequence, say HE, LE, HE, LE, etc., that sequence may be modified to double the ratio of LE pulses to HE pulses, thereby lowering the average dose rate incident upon the target.

The ratio of pulses per unit time of one energy with respect to another may be referred to, herein, as “the ratio of pulses of different energies of the generated x-ray beam.”

### Change in the Focal Spot Position

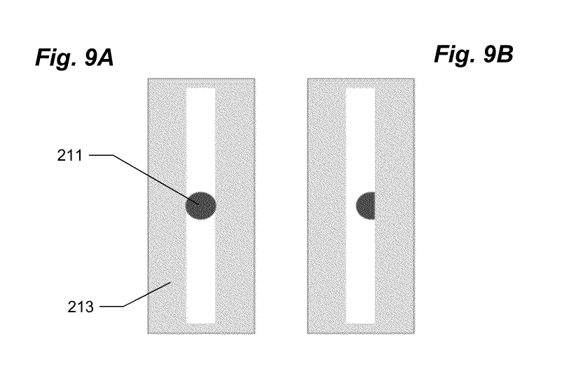

X-ray focal spot 211 (shown in FIG. 2) is the origin of x-rays 209 passing through an object being inspected and either scattered into the environment or recorded by detectors. Due to constraints imposed by the physics of electron optics, the focal spot has a finite size, usually on the order of one to three millimeters, and a typical distribution similar to a Gaussian distribution. Because only a narrow x-ray beam is of use for imaging with one-dimensional detector arrays, most of the x-rays produced have to be stopped by shielding and collimation. If any part of the focal spot is obstructed by shielding or collimation, the amount of x-rays (as defined above) reaching the detectors decreases. In order to maximize the x-ray dose rate, the collimation is typically designed such that the focal spot is unobstructed, as shown in FIG. 9A. However, this property can be used to change the dose rate from pulse to pulse.

Accordingly, when a lower dose is sought on the next pulse, just before the accelerator (an example of electron accelerating structure 201) fires, the electron beam focusing and steering system is adjusted such that the x-ray focal spot will be misaligned by a predefined distance relative to the collimator, as shown in FIG. 9B. The misalignment causes a predetermined fraction of the x-rays to be absorbed in the collimator and shielding resulting in a lower x-ray dose in the beam plane. A calibration map may be used to establish the relationship between the focal spot displacement and the dose rate incident on the inspected object.

### Change in the Focal Spot Focus

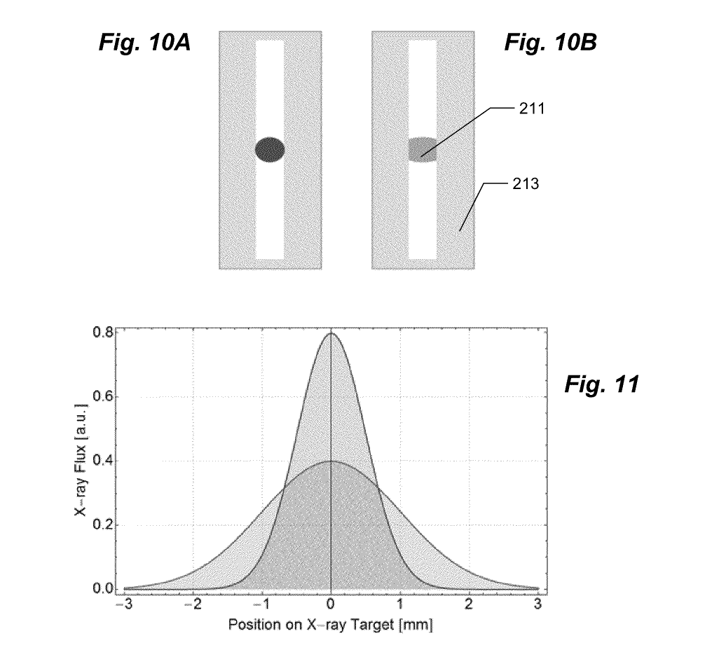

On a pulse-by-pulse basis, the electron beam focusing and steering system (part of electron accelerating structure 201, shown in FIG. 2) may be used to defocus the electron beam 203 in a direction coincident with propagation of the electron beam. Defocusing creates a focal spot 211 that emits the same amount of x-rays (as defined above) as when electron beam 203 is fully focused on target 207 (as viewed through source collimator 213 in FIG. 10A) but on a larger surface (as viewed through collimator 213 in FIG. 10B). Part of the focal spot is obstructed by the collimator 213 leading to a lower dose in the beam plane. Again, the dose rate is adjusted based on a pre-calibrated relationship between the electron beam focusing and the x-ray dose rate. The focal spot distributions for two focusing states are plotted in FIG. 11.

Joint variation of focal spot profile and position is an example of the use of multiple dynamic techniques for optimizing dose per pulse.

It is to be understood that the foregoing methods may be used in conjunction with multiple energy sources, whether multiple energies are emitted in distinct pulses or during the course of single pulses, or in conjunction with any other scheme of source configuration or operation that is known in the art.

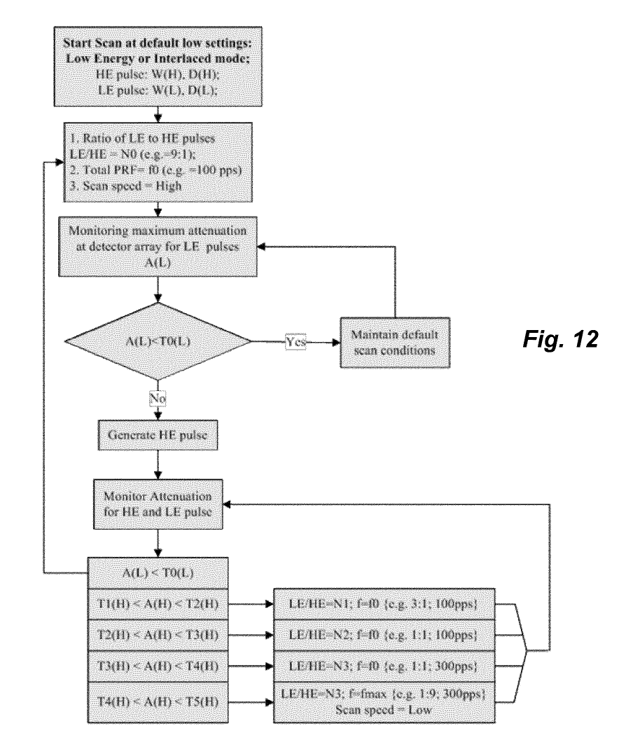

In the case of an x-ray source configured to produce interlaced pulses with at least two different energies, referred to herein as low energy (LE) and high energy (HE), an algorithm may be employed as depicted in the flowchart of FIG. 12.

The aforesaid x-ray pulses may be referred to as having corresponding energies W_{L} and W_{H} and doses per pulse D_{L}, D_{H}. (As used herein, the “energy” characterizing an x-ray pulse, if the pulse is characterized by a single energy, refers to the highest energy x-rays in the beam.

The following assumptions are made, for purposes of presenting an embodiment of the present invention:
The x-ray emission system 200 is capable of producing LE and HE pulses with a variable ratio (e.g., LE/HE=9:1 . . . =1:1 . . . =1:9), where LE and HE refer to the relative frequency of emission of pulses characterized by the respective end-point energies W_{L} and W_{H}.
The x-ray emission system 200 is capable of being run with a variable pulse repetition frequency (PRF) (e.g., in a range from 50 to 400 pps).
The accelerator structure 201 may include a dual-energy linac, or, alternatively, the accelerator structure 201 may include a multi-energy betatron.
Multiple x-ray detectors may be used to monitor a transmission signal, where, for purposes of the present application, the term “transmission signal” means the portion of x-ray beam 209 (shown in FIG. 2) that is transmitted through an inspected object at a specified position.
In accordance with embodiments of the present invention, a controller is provided that is adapted for monitoring maximum attenuation A caused by cargo under scanning, separately as A(L) for the LE pulse and as A(H) for the HE pulse.
The controller compares maximum attenuation with preset thresholds and sends the signal to X-ray source to set appropriate LE/HE ratio, PRF and scan speed.

In accordance with embodiments of the present invention, a controller is provided that is adapted for monitoring maximum attenuation A caused by cargo under scanning, separately as A(L) for the LE pulse and as A(H) for the HE pulse. The controller is adapted, further, to compare maximum attenuation with preset thresholds and send a signal to the x-ray source to set an appropriate LE/HE ratio, PRF and scan speed.

A scanning algorithm that may be employed in accordance with the system described above is now described with reference to FIG. 12.

A scan starts with LE/HE=N₀ at “low” PRF (e.g.,N₀=9:1; PRF=100 pps). The controller then compares maximum attenuation for low energy pulse with first threshold T₀(L) (defined based on low energy penetration capability). Until A(L)>T₀(L), the scan runs in default mode.

If above condition (A(L)<T₀(L)) is not true, the x-ray source generates the next pulse as a HE pulse.

The controller analyses attenuation for both LE and HE pulses and defines further scanning conditions as shown on FIG. 12 where LE/HE ratio, PRF and scan speed changes based on monitored attenuation for a linac-based x-ray source.

Where examples presented herein involve specific combinations of method acts or system elements, it should be understood that those acts and those elements may be combined in other ways to accomplish the same objective of x-ray dose reduction. Additionally, single device features may fulfill the requirements of separately recited elements of a claim. The embodiments of the invention described herein are intended to be merely exemplary; variations and modifications will be apparent to those skilled in the art. All such variations and modifications are intended to be within the scope of the present invention as defined in any appended claims.

What is claimed is:

1. A method for dynamically regulating x-ray dose, the method comprising:
a. generating an x-ray beam by impinging an electron beam upon an x-ray production target at a focal spot;
b. collimating the x-ray beam at a source collimator;
c. detecting a portion of the x-ray beam that traverses an inspected object; and
d. dynamically interposing a filter by translation of the filter between the focal spot and the source collimator in such a manner as to maintain the portion of the x-ray beam that traverses the inspected object below a specified limit.

2. A method in accordance with claim 1, wherein the filter is a whole-beam filter.

3. A method in accordance with claim 1, wherein the filter preferentially absorbs lower-energy x-rays.

4. A method in accordance with claim 1, wherein absorption by the filter is a function of filter position.

5. A method in accordance with claim 4, wherein the filter is a wedge filter.

6. A method in accordance with claim 4, wherein the absorption by the filter varies in a stepped manner with respect to filter position.

7. A method in accordance with claim 1, wherein the filter is a partial beam filter.

8. A method for dynamically regulating x-ray dose, the method comprising:
a. generating an x-ray beam by impinging an electron beam upon an x-ray production target at a focal spot;
b. collimating the x-ray beam at a source collimator;
c. detecting a portion of the x-ray beam that traverses an inspected object; and
d. varying a parameter of an aperture of the source collimator.

9. A method in accordance with claim 8, wherein the step of varying includes changing an aperture size of the source collimator.

10. A method in accordance with claim 8, wherein the step of varying includes changing a relative position of the focal spot and the source collimator.

11. A method for dynamically regulating x-ray dose, the method comprising:
a. generating an x-ray beam by impinging an electron beam upon an x-ray production target at a focal spot;
b. collimating the x-ray beam at a source collimator; and
c. varying a dimension characterizing the focal spot in such a manner as to maintain the portion of the x-ray beam that traverses the inspected object below a specified limit.

12. A method in accordance with claim 11, wherein varying a dimension characterizing the focal spot includes defocusing the focal spot.

13. A method for dynamically regulating x-ray dose, the method comprising:
a. generating an x-ray beam by impinging pulses of an electron beam of at least two distinct energies upon an x-ray production target at a focal spot; and
b. varying the ratio of pulses of different energies of the generated x-ray beam in response to radiation detected upon interaction of the x-ray beam with an inspected object.

14. An x-ray system for generating an x-ray beam of dynamically regulated dose, the x-ray system comprising:
a. an electron accelerating structure for accelerating a beam of electrons for formation of a focal spot on an x-ray producing target and for generating an x-ray beam;
b. a source collimator for collimating the x-ray beam;
c. a detector for receiving a portion of the x-ray beam that traverses an inspected object and for generating a detector signal;
d. a filter dynamically interposable by translation between the focal spot and the source collimator; and
e. a processor adapted to dynamically interpose the filter between the focal spot and the source collimator on a basis of the detector signal.

15. An x-ray system in accordance with claim 14, wherein the dynamically interposable filter is a whole beam filter.

16. An x-ray system in accordance with claim 14, wherein the dynamically interposable filter is a partial beam filter.
